(19) United States
(12) Patent Application Publication
(10) Pub. No.: US 2024/0102394 A1
(43) Pub. Date: Mar. 28, 2024

(54) RING SEGMENT FOR GAS TURBINE ENGINE

(71) Applicant: SIEMENS ENERGY GLOBAL GMBH & CO. KG, Munich (DE)

(72) Inventors: Atin Sharma, Pennington, NJ (US); Jesus Velez-Quinones, Jupiter, FL (US); Shantanu P. Mhetras, Charlotte, NC (US); Patrick M. Sedillo, York, SC (US)

(21) Appl. No.: 18/238,017

(22) Filed: Aug. 25, 2023

Related U.S. Application Data
(60) Provisional application No. 63/376,779, filed on Sep. 23, 2022.

(51) Int. Cl. F01D 9/04; F01D 25/12

(52) U.S. Cl. CPC F01D 9/04; F01D 25/12; F05D 2260/20; F05D 2300/611

(57) ABSTRACT

A ring segment for a gas turbine engine includes a forward mate face with respect to a circumferential flow component of a working fluid of the gas turbine engine, an aft mate face opposite to the forward mate face, an arcuate body extending between the forward mate face and the aft mate face, the arcuate body having a first surface facing to the working fluid and a second surface opposite to the first surface. The first surface includes an arcuate surface extending from the aft mate face toward the forward mate face, the arcuate surface having an arcuate cross section taken in a section plane that is normal to a central axis of the gas turbine engine, and a chamfered surface extending from the forward mate face toward the aft mate face, the chamfered surface having a non-arcuate cross section taken in the section plane.

### BACKGROUND

A gas turbine engine typically includes a compressor section, a turbine section, and a combustion section disposed therebetween. The compressor section includes multiple stages of rotating compressor blades and stationary compressor vanes. The combustion section typically includes a plurality of combustors. The turbine section includes multiple stages of rotating turbine blades and stationary turbine vanes. Turbine blades and vanes often operate in a high temperature environment and are internally cooled. The combustor may include fuel injectors for providing a fuel to be mixed with compressed air from the compressor section and an ignition source for igniting the mixture to form hot exhaust gas for the turbine section.

### BRIEF SUMMARY

In one aspect, a ring segment for a gas turbine engine includes a forward mate face with respect to a circumferential flow component of a working fluid of the gas turbine engine, an aft mate face opposite to the forward mate face, an arcuate body that extends between the forward mate face and the aft mate face, the arcuate body having a first surface facing to the working fluid and a second surface opposite to the first surface. The first surface includes an arcuate surface that extends from the aft mate face toward the forward mate face, the arcuate surface having an arcuate cross section taken in a section plane that is normal to a central axis of the gas turbine engine. The first surface includes a chamfered surface that extends from the forward mate face toward the aft mate face, the chamfered surface having a non-arcuate cross section taken in the section plane.

In one aspect, a ring segment for a gas turbine engine includes a forward mate face with respect to a circumferential flow component of a working fluid of the gas turbine engine, an aft mate face opposite to the forward mate face, an arcuate body that extends between the forward mate face and the aft mate face, the arcuate body having a first surface facing to the working fluid and a second surface opposite to the first surface. The first surface includes an arcuate surface that extends from the aft mate face toward the forward mate face, the arcuate surface having an arcuate cross section taken in a section plane that is normal to a central axis of the gas turbine engine. The first surface includes a chamfered surface that extends from the forward mate face toward the aft mate face, the chamfered surface having a non-arcuate cross section taken in the section plane. The ring segment includes a forward edge formed at an intersection of the chamfered surface and the forward mate face, the forward edge including a forward fillet.

### BRIEF DESCRIPTION OF THE DRAWINGS

To easily identify the discussion of any particular element or act, the most significant digit or digits in a reference number refer to the figure number in which that element is first introduced.

FIG. 1 is a longitudinal cross-sectional view of a gas turbine engine taken along a plane that contains a longitudinal axis or central axis.

FIG. 2 is a schematic circumferential cross section view of a ring segment assembly having a plurality of ring segments for use with the gas turbine engine shown in FIG. 1.

FIG. 3 is a perspective view of a ring segment shown in FIG. 2.

FIG. 4 is a portion of the ring segment shown in FIG. 3 better illustrating a chamfered surface.

FIG. 5 is a schematic view of a portion of the ring segment assembly having two adjacent ring segments shown in FIG. 3.

### DETAILED DESCRIPTION

Before any embodiments of the invention are explained in detail, it is to be understood that the invention is not limited in its application to the details of construction and the arrangement of components set forth in this description or illustrated in the following drawings. The invention is capable of other embodiments and of being practiced or of being carried out in various ways. Also, it is to be understood that the phraseology and terminology used herein is for the purpose of description and should not be regarded as limiting.

Various technologies that pertain to systems and methods will now be described with reference to the drawings, where like reference numerals represent like elements throughout. The drawings discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged apparatus. It is to be understood that functionality that is described as being carried out by certain system elements may be performed by multiple elements. Similarly, for instance, an element may be configured to perform functionality that is described as being carried out by multiple elements. The numerous innovative teachings of the present application will be described with reference to exemplary non-limiting embodiments.

It should be understood that the words or phrases used herein should be construed broadly, unless expressly limited in some examples. For example, the terms “including”, “having”, and “comprising”, as well as derivatives thereof, mean inclusion without limitation. The singular forms “a”, “an”, and “the” are intended to include the plural forms as well, unless the context clearly indicates otherwise. Further, the term “and/or” as used herein refers to and encompasses any and all possible combinations of one or more of the associated listed items. The term “or” is inclusive, meaning and/or, unless the context clearly indicates otherwise. The phrases “associated with” and “associated therewith” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Furthermore, while multiple embodiments or constructions may be described herein, any features, methods, steps, components, etc. described with regard to one embodiment are equally applicable to other embodiments absent a specific statement to the contrary.

Terms such as “first”, “second”, “third” and so forth may be used herein to refer to various elements, information, functions, or acts, these elements, information, functions, or acts should not be limited by these terms. Rather these numeral adjectives are used to distinguish different elements, information, functions or acts from each other. For example, a first element, information, function, or act could be termed a second element, information, function, or act, and, similarly, a second element, information, function, or act could be termed a first element, information, function, or act, without departing from the scope of the present disclosure.

In the description, the terms “axial” or “axially” refer to a direction along a longitudinal axis of a gas turbine engine. The terms “radial” or “radially” refer to a direction perpendicular to the longitudinal axis of the gas turbine engine. The terms “downstream” or “aft” refer to a direction along a flow direction. The terms “upstream” or “forward” refer to a direction against the flow direction.

In addition, the term “adjacent to” may mean that an element is relatively near to but not in contact with a further element or that the element is in contact with the further portion, unless the context clearly indicates otherwise. Further, the phrase “based on” is intended to mean “based, at least in part, on” unless explicitly stated otherwise.

Terms “about” or “substantially” or like terms are intended to cover variations in a value that are within normal industry manufacturing tolerances for that dimension. If no industry standard is available, a variation of twenty percent would fall within the meaning of these terms unless otherwise stated.

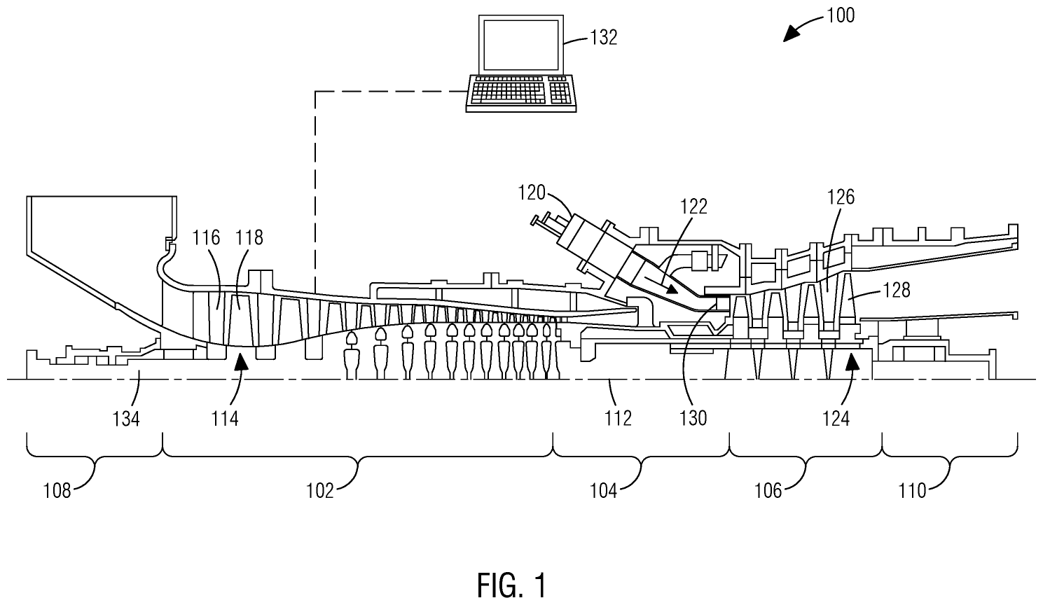

FIG. 1 illustrates an example of a gas turbine engine 100 including a compressor section 102, a combustion section 104, and a turbine section 106 arranged along a central axis 112. The compressor section 102 includes a plurality of compressor stages 114 with each compressor stage 114 including a set of stationary compressor vanes 116 or adjustable guide vanes and a set of rotating compressor blades 118. A rotor 134 supports the rotating compressor blades 118 for rotation about the central axis 112 during operation. In some constructions, a single one-piece rotor 134 extends the length of the gas turbine engine 100 and is supported for rotation by a bearing at either end. In other constructions, the rotor 134 is assembled from several separate spools that are attached to one another or may include multiple disk sections that are attached via a bolt or plurality of bolts.

The compressor section 102 is in fluid communication with an inlet section 108 to allow the gas turbine engine 100 to draw atmospheric air into the compressor section 102. During operation of the gas turbine engine 100, the compressor section 102 draws in atmospheric air and compresses that air for delivery to the combustion section 104. The illustrated compressor section 102 is an example of one compressor section 102 with other arrangements and designs being possible.

In the illustrated construction, the combustion section 104 includes a plurality of separate combustors 120 that each operate to mix a flow of fuel with the compressed air from the compressor section 102 and to combust that air-fuel mixture to produce a flow of high temperature, high pressure combustion gases or exhaust gas 122. Of course, many other arrangements of the combustion section 104 are possible.

The turbine section 106 includes a plurality of turbine stages 124 with each turbine stage 124 including a number of stationary turbine vanes 126 and a number of rotating turbine blades 128. The turbine stages 124 are arranged to receive the exhaust gas 122 from the combustion section 104 at a turbine inlet 130 and expand that gas to convert thermal and pressure energy into rotating or mechanical work. The turbine section 106 is connected to the compressor section 102 to drive the compressor section 102. For gas turbine engines 100 used for power generation or as prime movers, the turbine section 106 is also connected to a generator, pump, or other device to be driven. As with the compressor section 102, other designs and arrangements of the turbine section 106 are possible.

An exhaust portion 110 is positioned downstream of the turbine section 106 and is arranged to receive the expanded flow of exhaust gas 122 from the final turbine stage 124 in the turbine section 106. The exhaust portion 110 is arranged to efficiently direct the exhaust gas 122 away from the turbine section 106 to assure efficient operation of the turbine section 106. Many variations and design differences are possible in the exhaust portion 110. As such, the illustrated exhaust portion 110 is but one example of those variations.

A control system 132 is coupled to the gas turbine engine 100 and operates to monitor various operating parameters and to control various operations of the gas turbine engine 100. In preferred constructions the control system 132 is typically micro-processor based and includes memory devices and data storage devices for collecting, analyzing, and storing data. In addition, the control system 132 provides output data to various devices including monitors, printers, indicators, and the like that allow users to interface with the control system 132 to provide inputs or adjustments. In the example of a power generation system, a user may input a power output set point and the control system 132 may adjust the various control inputs to achieve that power output in an efficient manner.

The control system 132 can control various operating parameters including, but not limited to variable inlet guide vane positions, fuel flow rates and pressures, engine speed, valve positions, generator load, and generator excitation. Of course, other applications may have fewer or more controllable devices. The control system 132 also monitors various parameters to assure that the gas turbine engine 100 is operating properly. Some parameters that are monitored may include inlet air temperature, compressor outlet temperature and pressure, combustor outlet temperature, fuel flow rate, generator power output, bearing temperature, and the like. Many of these measurements are displayed for the user and are logged for later review should such a review be necessary.

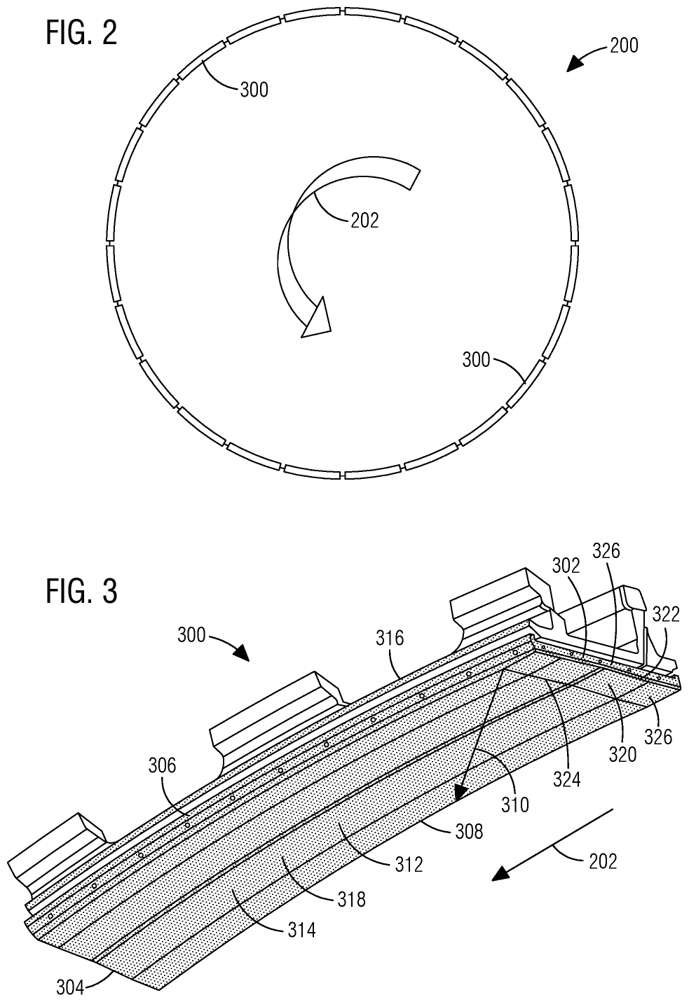

FIG. 2 illustrates a schematic circumferential cross section view of a ring segment assembly 200 for use with the gas turbine engine 100 shown in FIG. 1. The ring segment assembly 200 includes a plurality of ring segments 300 that are assembled circumferentially. The ring segment assembly 200 is disposed adjacent to a tip of the plurality of rotating turbine blades 128 (not shown in FIG. 2) with a gap therebetween.

The plurality of rotating turbine blades 128 rotate in a rotation direction 202 about the central axis 112. In the construction shown in FIG. 2, the rotation direction 202 of the plurality of rotating turbine blades 128 is counterclockwise looking from the inlet section 108. In other constructions, the rotation direction 202 of the plurality of rotating turbine blades 128 may be clockwise looking from the inlet section 108.

In the construction shown in FIG. 2, the ring segment assembly 200 has a total of 24 ring segments 300. In other constructions, the ring segment assembly 200 may have another quantity of ring segments 300.

FIG. 3 illustrates a perspective view of the ring segment 300 shown in FIG. 2. The ring segment 300 has a forward mate face 302 with respect to the rotation direction 202 and an aft mate face 304 opposite to the forward mate face 302. The forward mate face 302 of one ring segment 300 faces to the aft mate face 304 of an adjacent ring segment 300 once they are assembled in the ring segment assembly 200. The ring segment 300 has an upstream side face 306 and a downstream side face 308 with respect to a direction of a working fluid 310. The working fluid 310 includes the exhaust gas 122 shown in FIG. 1.

An arcuate body 312 extends between the forward mate face 302 and the aft mate face 304 and between the upstream side face 306 and the downstream side face 308. The arcuate body 312 has a first surface 314 facing to the working fluid 310 and a second surface 316 that is opposite to the first surface 314. A circumferential length of the arcuate body 312 is defined between the forward mate face 302 and the aft mate face 304. A thickness of the arcuate body 312 is defined between the first surface 314 and the second surface 316.

The first surface 314 includes an arcuate surface 318 and a chamfered surface 320. The arcuate surface 318 extends from the aft mate face 304 toward the forward mate face 302 and has an arcuate cross section taking in a section plane that is normal to the central axis 112. The arcuate surface 318 may be contoured. For example, the arcuate surface 318 may include bumps and valleys to form a wavy surface. The contoured arcuate surface 318 becomes flatter in a hot condition than in a cold condition to improve control of a tip clearance between the ring segment 300 and the rotating turbine blade 128. The contoured arcuate surface 318 also improves aerodynamic performance of the ring segment 300.

The chamfered surface 320 extends from the forward mate face 302 toward the aft mate face 304. In the construction shown in FIG. 3, the chamfered surface 320 has a non-arcuate cross section taking in the section plane. In other constructions, the chamfered surface 320 may include other shapes as needed by a performance requirement of the gas turbine engine 100.

The chamfered surface 320 includes a forward edge 322 and an aft edge 324. The forward edge 322 intersects with the forward mate face 302. The aft edge 324 connects with the arcuate surface 318. The chamfered surface 320 extends from the forward edge 322 to the aft edge 324. The aft edge 324 is arranged between the forward mate face 302 and the aft mate face 304 and is positioned between 5-30% of the circumferential length of the arcuate body 312. In the construction shown in FIG. 3, the chamfered surface 320 results in a first thickness that is defined between the first surface 314 and the second surface 316 measured at the forward mate face 302 and results in a second thickness that is defined between the first surface 314 and the second surface 316 measured at the aft edge 324 with the first thickness being between 80-98% of the thickness of the arcuate body 312. The second thickness is the same as the thickness of the arcuate body 312. In other constructions, the chamfered surface 320 may have different dimensions and/or geometries as needed by a performance requirement of the gas turbine engine 100.

A coating 326 is applied to the first surface 314 including the arcuate surface 318 and the chamfered surface 320. The coating 326 is also applied to the forward mate face 302 and the upstream side face 306. The coating 326 is also applied to the aft mate face 304 (shown in FIG. 5). In other constructions, the coating 326 may be applied to other locations as needed by a performance requirement of the gas turbine engine 100. The coating 326 may include a layer of bond coating, a layer or multiple layers of thermal barrier coating, and a layer of abradable coating. The coating 326 may be made with a high fracture toughness material to improve its strength and toughness. The high fracture toughness material may include Yttria Partially Stabilized Zirconia, etc. A porosity of the coating 326 may be less than 10%, or less than 8%, or less than 5%. The less porosity results in the higher fracture toughness. The porosity is the percentage of void space in a volume of the coating 326. It is defined as the ratio of the volume of the voids or pore space divided by the total volume of the coating 326. In some constructions, the coating 326 may include surface engineering, such as machined grooves, that affectively increases the porosity in the volume that contains the surface engineering.

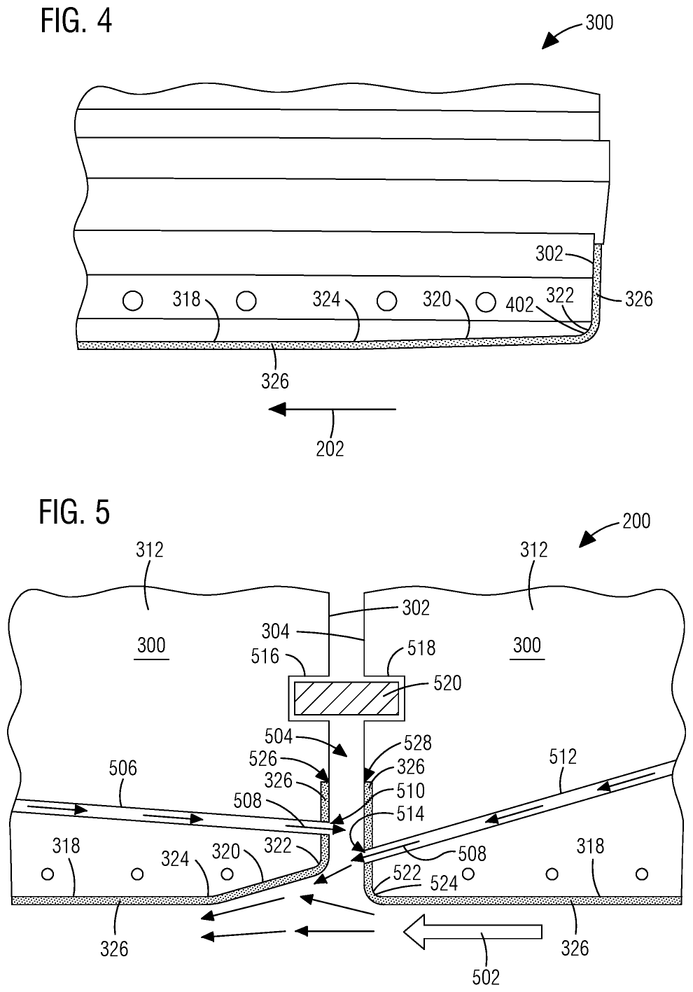

FIG. 4 illustrates a portion of the ring segment 300 shown in FIG. 3 that better illustrates the chamfered surface 320. The forward edge 322 includes a forward fillet 402 having a radius that is between 2-50% of the thickness of the arcuate body 312. In other constructions, the forward fillet 402 may have a radius with other dimensions as needed by the performance requirement of the gas turbine engine 100.

FIG. 5 illustrates a schematic view of a portion of the ring segment assembly 200 having two adjacent ring segments 300 shown in FIG. 3. The forward mate face 302 faces a circumferential flow component 502 that is a portion of the working fluid 310 flowing circumferentially due to the rotation of the rotating turbine blades 128. The forward mate face 302 of one ring segment 300 is adjacent to the aft mate face 304 of the adjacent ring segment 300. A mate face gap 504 exists between the forward mate face 302 and the aft mate face 304 of the adjacent ring segment assembly 200.

The ring segment 300 includes a forward cooling channel 506 that is disposed within the arcuate body 312. The forward cooling channel 506 intersects the forward mate face 302 to define a forward cooling hole 510. A cooling flow 508 flows within the forward cooling channel 506 and exits the ring segment 300 through the forward cooling hole 510. The forward cooling channel 506 is arranged at an acute angle with respect to the forward mate face 302. In other constructions, the forward cooling channel 506 may be perpendicular to the forward mate face 302. The forward cooling channel 506 may be one of a plurality of forward cooling channels 506 that are disposed within the arcuate body 312. The forward cooling hole 510 may be one of plurality of forward cooling holes 510 that are disposed at the forward mate face 302. Each forward cooling channel 506 of the plurality of forward cooling channels 506 exits the ring segment 300 through a respective forward cooling hole 510 of the plurality of forward cooling holes 510.

The ring segment 300 includes an aft cooling channel 512 disposed that is disposed within the arcuate body 312. The aft cooling channel 512 intersects the aft mate face 304 to define an aft cooling hole 514. The cooling flow 508 flows within the aft cooling channel 512 and exits the ring segment 300 through the aft cooling hole 514. The aft cooling channel 512 is arranged at an acute angle with respect to the aft mate face 304. In other constructions, the aft cooling channel 512 may be perpendicular to the aft mate face 304. The aft cooling channel 512 may be one of a plurality of cooling channels 512 that are disposed within the arcuate body 312. The aft cooling hole 514 may be one of the plurality of aft cooling holes 514 that are disposed at the aft mate face 304. Each aft cooling channel 512 of the plurality of cooling channels 512 exits the ring segment 300 through a respective aft cooling hole 514 of the plurality of aft cooling holes 514.

The chamfered surface 320 has an acute angle with respect to the forward mate face 302. The acute angle of the chamfered surface 320 equals to the acute angle of the aft cooling channel 512. Quantity of equal is defined as equal or less than 5 degrees. In other constructions, the acute angle of the chamfered surface 320 may be different than the acute angle of the aft cooling channel 512. Quantity of difference is defined as more than 5 degrees.

The ring segment 300 has a forward chute 516 that is disposed at the forward mate face 302 and an aft chute 518 that is disposed at the aft mate face 304. A seal 520 is disposed into the forward chute 516 and the aft chute 518 of the adjacent ring segment 300.

The aft mate face 304 intersects with the arcuate surface 318 forming an aft mate face edge 522. The aft mate face edge 522 includes an aft fillet 524. The coating 326 is applied to the aft mate face 304 including the aft fillet 524. A forward recess 526 is defined at the forward mate face 302. An aft recess 528 is defined at the aft mate face 304.

During operation of the gas turbine engine 100, with reference to FIG. 2 to FIG. 5, the circumferential flow component 502 flows in the same direction as the rotation direction 202 of the rotating turbine blades 128 and has a similar high temperature as the working fluid 310. The circumferential flow component 502 flows to the forward mate face 302 and strikes the chamfered surface 320 and the forward edge 322. The chamfered surface 320 and the forward edge 322 directs the circumferential flow component 502 flowing along the chamfered surface 320 to the arcuate surface 318 toward a forward mate face 302 of an adjacent ring segment 300 in the ring segment assembly 200. In comparison to a ring segment 300 without the chamfered surface 320, the circumferential flow component 502 is diverted into the mate face gap 504 and circulate in the mate face gap 504. As such, the forward mate face 302 experiences a higher temperature than the aft mate face 304. The chamfered surface 320 reduces circulation of the circumferential flow component 502 into the mate face gap 504 and thus reduces the heat transfer at the forward edge 322. The chamfered surface 320 also reduces incident angle from abrasive particles flowing through the gas turbine engine 100. The forward fillet 402 at the forward edge 322 improves protection of the forward edge 322 from a strike of the circumferential flow component 502. The forward fillet 402 of the forward edge 322 and the aft fillet 524 of the aft mate face edge 522 also allow for around application of the coating 326 at the forward edge 322 and at the aft mate face edge 522, respectively, to reduce loss of the coating 326 at the forward edge 322 and at the aft mate face edge 522.

The coating 326 is applied to a part of the ring segment 300, such as to the first surface 314 including the arcuate surface 318 and the chamfered surface 320, to the forward mate face 302, to the aft mate face 304, to the upstream side face 306, or to the entire ring segment 300. The coating 326 has a high density and high fracture toughness. The denser and higher fracture toughness coating 326 reduces the temperature increase on the ring segment 300 and reduces chipping and/or spallation from the ring segment 300. The forward recess 526 and the aft recess 528 protect the coating 326 at the forward mate face 302 and the aft mate face 304 from damage.

The cooling flow 508 exiting from the forward cooling channel 506 and the aft cooling channel 512 can purge the mate face gap 504 to reduce or prevent aft mate face 304 ingestion of the circumferential flow component 502. The aft cooling channel 512 has an acute angle that equals to an acute angle of the chamfered surface 320 of an adjacent ring segment 300 such that the cooling flow 508 exiting the aft cooling channel 512 provides a film cooling effect to the chamfered surface 320 of the adjacent ring segment 300. The cooling flow 508 exiting from the aft cooling channel 512 also further improves the protection of the forward edge 322 from the strike of the circumferential flow component 502. The angled aft cooling channel 512 reduces an incident angle of the cooling flow 508 onto the coating 326 on the forward mate face 302 to reduce a risk of damage of the coating 326 due to impingement of the cooling flow 508.

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, act, or function is an essential element, which must be included in the claim scope: the scope of patented subject matter is defined only by the allowed claims. Moreover, none of these claims are intended to invoke a means plus function claim construction unless the exact words “means for” are followed by a participle.

### LISTING OF DRAWING ELEMENTS

100 gas turbine engine
102 compressor section
104 combustion section
106 turbine section
108 inlet section
110 exhaust portion
112 central axis
114 compressor stage
116 stationary compressor vane
118 rotating compressor blade
120 combustor
122 exhaust gas
124 turbine stage
126 stationary turbine vane
128 rotating turbine blade
130 turbine inlet
132 control system
134 rotor
200 ring segment assembly
202 rotation direction
300 ring segment
302 forward mate face
304 aft mate face
306 upstream side face
308 downstream side face
310 working fluid
312 arcuate body
314 first surface
316 second surface
318 arcuate surface
320 chamfered surface
322 forward edge
324 aft edge
326 coating
402 forward fillet
502 circumferential flow component
504 mate face gap
506 forward cooling channel
508 cooling flow
510 forward cooling hole
512 aft cooling channel
514 aft cooling hole
516 forward chute
518 aft chute
520 seal
522 aft mate face edge
524 aft fillet
526 forward recess
528 aft recess

What is claimed is:

1. A ring segment comprising:
a forward mate face with respect to a circumferential flow component of a working fluid of the gas turbine engine;
an aft mate face opposite to the forward mate face;
an arcuate body that extends between the forward mate face and the aft mate face, the arcuate body having a first surface facing to the working fluid and a second surface opposite to the first surface, the first surface comprising:
an arcuate surface that extends from the aft mate face toward the forward mate face, the arcuate surface having an arcuate cross section taken in a section plane that is normal to a central axis of the gas turbine engine; and
a chamfered surface that extends from the forward mate face toward the aft mate face, the chamfered surface having a non-arcuate cross section taken in the section plane.

2. The ring segment of claim 1, wherein the chamfered surface extends from a forward edge to an aft edge, and wherein the forward edge intersects with the forward mate face and the aft edge connects the arcuate surface.

3. The ring segment of claim 2, wherein the arcuate body defines a circumferential length that is defined between the forward mate face to the aft mate face, and wherein the aft edge is positioned between 5-30% of the circumferential length.

4. The ring segment of claim 2, wherein the chamfered surface defines a first thickness that is defined between the first surface and the second surface measured at the forward edge and a second thickness that is defined between the first surface and the second surface measured at the aft edge, and wherein the first thickness is between 80-98% of the second thickness.

5. The ring segment of claim 2, wherein the forward edge comprises a forward fillet.

6. The ring segment of claim 5, wherein a radius of the forward fillet is between 2-50% of the second thickness.

7. The ring segment of claim 1, further comprising a coating applied to the first surface and the forward mate face, wherein the coating has a porosity that is less than 10%.

8. The ring segment of claim 1, wherein the ring segment is one of a plurality of ring segments arranged circumferentially to define a ring segment assembly, and wherein the forward mate face of each ring segment of the plurality of ring segments is positioned opposite to the aft mate face of an adjacent ring segment of the plurality of ring segments to encircle a central axis of the gas turbine engine.

9. The ring segment of claim 1, further comprising a forward cooling channel disposed within the arcuate body, wherein the forward cooling channel defines an acute angle with respect to the forward mate face.

10. The ring segment of claim 1, further comprising an aft cooling channel disposed within the arcuate body, wherein the aft cooling channel defines an acute angle with respect to the aft mate face.

11. The ring segment of claim 10, wherein the chamfered surface defines an acute angle with respect to the forward mate face, and wherein the acute angle of the chamfered surface equals to the acute angle of the aft cooling channel.

12. A ring segment comprising:
a forward mate face with respect to a circumferential flow component of a working fluid of the gas turbine engine;
an aft mate face opposite to the forward mate face;
an arcuate body that extends between the forward mate face and the aft mate face, the arcuate body having a first surface facing to the working fluid and a second surface opposite to the first surface, the first surface comprising:
an arcuate surface that extends from the aft mate face toward the forward mate face, the arcuate surface having an arcuate cross section taken in a section plane that is normal to a central axis of the gas turbine engine; and
a chamfered surface that extends from the forward mate face toward the aft mate face, the chamfered surface having a non-arcuate cross section taken in the section plane; and
a forward edge formed at an intersection of the chamfered surface and the forward mate face, the forward edge comprising a forward fillet.

13. The ring segment of claim 12, wherein the chamfered surface extends from the forward edge to an aft edge, and wherein the aft edge connects the arcuate surface.

14. The ring segment of claim 13, wherein the arcuate body defines a circumferential length that is defined between the forward mate face to the aft mate face, and wherein the aft edge is positioned between 5-30% of the circumferential length.

15. The ring segment of claim 13, wherein the chamfered surface defines a first thickness that is defined between the first surface and the second surface measured at the forward edge and a second thickness that is defined between the first surface and the second surface measured at the aft edge, and wherein the first thickness is between 80-98% of the second thickness.

16. The ring segment of claim 15, wherein a radius of the forward fillet is between 2-50% of the second thickness.

17. The ring segment of claim 12, further comprising a coating applied to the first surface and the forward mate face, wherein the coating has a porosity that is less than 10%.

18. The ring segment of claim 12, wherein the ring segment is one of a plurality of ring segments arranged circumferentially to define a ring segment assembly, and wherein the forward mate face of each ring segment of the plurality of ring segments is positioned opposite to the aft mate face of an adjacent ring segment of the plurality of ring segments to encircle a central axis of the gas turbine engine.

19. The ring segment of claim 12, further comprising an aft cooling channel disposed within the arcuate body, wherein the aft cooling channel defines an acute angle with respect to the aft mate face.

20. The ring segment of claim 19, wherein the chamfered surface defines an acute angle with respect to the forward mate face, and wherein the acute angle of the chamfered surface equals to the acute angle of the aft cooling channel.
